(19) United States
(12) Patent Application Publication
(10) Pub. No.: US 2020/0284304 A1
(43) Pub. Date: Sep. 10, 2020

(54) Clutch Device for Torsionally Flexible Torque Transmission

(71) Applicant: Stromag GmbH, Unna (DE)

(72) Inventors: Peter Böhm, Unna (DE); Friedrich Faust, Ahlen (DE); Olaf Mikolajczyk, Unna (DE); Daniela Spink, Unna (DE)

(21) Appl. No.: 16/775,486

(22) Filed: Jan. 29, 2020

(30) Foreign Application Priority Data
Mar. 7, 2019 (DE) 10 2019 203 109.9

(51) Int. Cl. F16D 13/68; F16D 3/52

(52) U.S. Cl. CPC F16D 13/68; F16D 3/52

(57) ABSTRACT

A clutch device includes a clutch hub radially inward of a clutch rotational axis on a hub side of the device, a clutch flange radially outward on a flange side of the device, a spring device through which the hub and flange sides support each other in the circumferential direction in a resilient torque-transmitting manner, the spring device having a spring element that, in the circumferential direction, is supported at opposite ends by first and second support components assigned to the flange and hub, and a stop device through which the hub and flange sides support each other in an interlocking torque-transmitting manner in the circumferential direction when a defined maximum twist angle is reached between the hub and flange sides, wherein the stop device has first and second interlocking elements integrally formed with the first and second support components that interlock when the maximum twist angle is reached.

### BACKGROUND OF THE INVENTION

### a. Field of the Invention

The invention relates to a clutch device for torsionally flexible torque transmission, having a clutch hub that lies radially to the inside relative to a clutch rotational axis and is assigned to a hub side of the clutch device, a clutch flange that lies radially to the outside and is assigned to a flange side of the clutch device, a spring device by means of which the hub side and the flange side support each other in the circumferential direction in a resilient torque-transmitting manner, for which purpose the spring device has at least one spring element that, in the circumferential direction, is supported at one end by a first support component assigned to the clutch flange and at the other end by a second support component assigned to the clutch hub, and having a stop device by means of which the hub side and the flange side support each other in an interlocking torque-transmitting manner in the circumferential direction when a defined maximum twist angle is reached between the hub side and the flange side.

### b. Background Art

A clutch device of this type is generally known in the field of drive engineering and is provided for torsionally flexible torque transmission in a drive train. The known clutch device has a radially inner clutch hub and a radially outer clutch flange. The clutch flange and the clutch hub support each other in the circumferential direction in a resilient torque-transmitting manner by means of a spring device. For this purpose, the spring device of the known clutch device provides a plurality of compression springs arranged adjacently in the circumferential direction, each of which is supported at one end by a first support component assigned to the clutch flange and at the other end by a second support component assigned to the clutch hub. In order to limit the elastic rotatability between the clutch flange and clutch hub, a stop device is provided. In the known clutch device, the stop device has a plurality of stop elements which are manufactured separately from the other components and/or sections of the clutch device and are mounted in a separate assembly step between the hub side and the flange side. When a structurally defined maximum twist angle is reached between the clutch flange and the clutch hub, the stop elements act as an interlocking stop.

### BRIEF SUMMARY OF THE INVENTION

The object of the invention is to provide a clutch device of the type mentioned at the onset which has a simplified design and enables simplified production and assembly.

This object is achieved in that the stop device has at least one first interlocking element integrally formed with the first support component and at least one second interlocking element integrally formed with the second support component, wherein the first interlocking element and the second interlocking element interlock when the maximum twist angle is reached. The solution according to the invention makes it possible to dispense with separately manufactured stop elements which are to be mounted in a separate assembly step. Instead, the stop device has the at least one first interlocking element and the at least one second interlocking element, wherein the interlocking elements are each formed integrally on the first and second support component respectively. As a result, a simplified design of the clutch device and simplified production and assembly thereof can be achieved. The clutch device is preferably provided for transmitting a torque between a transmission and an engine of a drive train. The clutch hub can be provided in particular for the torque-proof connection to an input shaft of a transmission or an output shaft of a drive motor. Accordingly, the clutch flange can be provided in particular for the torque-proof connection to an input flange of a transmission or an output flange of an engine. The spring device brings about a resilient connection between the flange side and the hub side in the circumferential direction so that drive-related, sudden peaks in the torque to be transmitted are transmitted between the flange side and the hub side not more-or-less inflexibly and thus suddenly but instead torsionally flexibly. For this purpose, the hub side and the clutch side are resiliently rotatable relative to one another by means of the spring device. For resilient support between the hub side and the flange side, the spring device provides the at least one spring element. The at least one spring element is preferably a compression spring. The spring device preferably has a plurality of identical spring elements which are arranged to be spaced from each other in the circumferential direction and which each are supported by the first support component and the second support component. The stop device permits only a limited resilient rotatability between the hub side and the flange side. The maximum twist angle is defined structurally by means of the stop device. The first support component is assigned to the clutch flange and can in particular be a sheet-metal component manufactured from sheet metal or a cast component. The second support component is assigned to the clutch hub and can in particular be a sheet-metal component manufactured from sheet metal or a cast component. The first support component can be detachably or non-detachably joined to the clutch flange and/or formed integrally on the clutch flange. The second support component can be detachably or non-detachably joined to the clutch hub or formed integrally therewith. If the relevant support component is a sheet-metal component, the relevant interlocking element can in particular be a sheet-metal section formed by means of shaping, or an opening cut out of the sheet-metal component. If the relevant support component is a cast component, the relevant interlocking element can be formed in particular by a projecting cast section or by a recess in the cast component.

In an embodiment of the invention, the first support component and/or the second support component is designed in the form of a sheet-metal component made of sheet metal, and the first interlocking element and/or the second interlocking element is designed in the form of a shaped sheet-metal section. The first interlocking element is preferably formed to be complementary to the second interlocking element and can accordingly be designed in particular in the form of an opening, a recess, a groove or the like, which interlocks with the shaped sheet-metal section when the maximum twist angle is reached. The shaped sheet-metal section can in particular be designed in the form of a tab, a tine, a bulge or the like. This embodiment of the invention makes it possible to achieve a particularly simple design, and particularly simple manufacturing and assembly of the clutch device.

In a further embodiment of the invention, a plurality of first interlocking elements that are arranged to be spaced in the circumferential direction and a plurality of second interlocking elements that are arranged to be spaced in the circumferential direction are provided. This embodiment of the invention ensures a particularly dependable and functionally reliable limitation of the maximum twist angle. Preferably, one of the first interlocking elements interlocks with one each of the second interlocking elements. Preferably, at least two, preferably at least four, particularly preferably at least eight, first interlocking elements and second interlocking elements are respectively provided.

In a further embodiment of the invention, the first support component is a first cage plate of a cage assembly for holding the at least one spring element, wherein the first cage plate is joined at its outer circumference to the clutch flange in a torque-proof manner, and the second support component is a support plate which is joined at its inner circumference to the clutch hub in a torque-proof manner. The support plate preferably has an annular basic shape and extends radially to the outside from the clutch hub. The support plate can have a recess which extends in the axial direction and in which the at least one spring element is arranged. The support plate serves in particular to transmit torque between the spring device and the clutch hub. The first cage plate serves in particular to hold the at least one spring element in an interlocking manner and to transmit torque between the spring device and the clutch flange. At its outer circumference, the first cage plate can be detachably or non-detachably joined to the clutch flange or formed integrally therewith. Accordingly, the support plate can at its inner circumference be detachably or non-detachably joined to the clutch hub or formed integrally therewith. By arranging the first interlocking element on the first cage plate and the second interlocking element on the support plate, a further simplified design of the clutch device is achieved. In addition, particular advantages are obtained with regard to the manufacture and assembly of the clutch device.

In a further embodiment of the invention, the at least one second interlocking element is an axial opening cut out of the support plate, and the at least one first interlocking element is a bent tab of the first cage plate extending into the axial opening. The tab projects axially into the opening and, upon reaching the maximum twist angle, comes to rest laterally in the circumferential direction against an inner contour of the opening. In this way, a particularly simple and reliable interlocking twist angle limitation and torque transmission is achieved.

In a further embodiment of the invention, the cage assembly has a second cage plate which is arranged on a side of the support plate facing away from the first cage plate and is provided with at least one further tab which extends into a further axial opening in the support plate. The further tab of the second cage plate is preferably designed to be similar to the bent tab of the first cage plate and oriented opposite thereto in the axial direction. The second cage plate is spaced from the first cage plate in the axial direction, wherein the support plate is preferably arranged between the two cage plates. In such an embodiment of the invention, the support plate can also be referred to as the center plate. A particularly simple design can be achieved if the first cage plate and the second cage plate are mirror-symmetrical with respect to an axial plane. This embodiment of the invention enables a further simplified design. Moreover, production and assembly are additionally simplified.

### BRIEF DESCRIPTION OF THE DRAWINGS

Further advantages and features of the invention result from the claims and also from the following description of a preferred exemplary embodiment of the invention, which is described with reference to the drawings.

FIG. 1 shows a schematic perspective view of an embodiment of a clutch device according to the invention.

FIG. 2 shows the clutch device according to FIG. 1 in a view directed along a clutch rotational axis with the insertion of concealed lines and cut-free regions.

FIG. 3 shows the clutch device according to FIGS. 1 and 2 in an enlarged, partially cut-away sectional view along section line A-A according to FIG. 2.

FIG. 4 shows the clutch device according to FIGS. 1 to 3 in a manner corresponding to FIG. 3 along section line B-B according to FIG. 2.

FIG. 5 shows the clutch device according to FIGS. 1 to 4 in a partially cut-away sectional view with a rotated perspective.

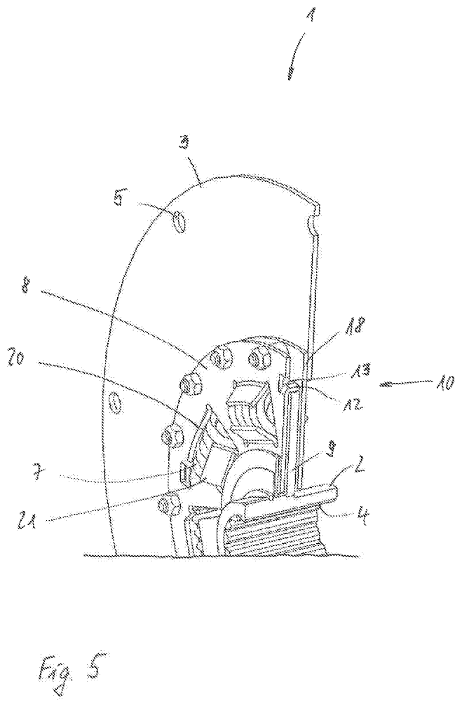

### DETAILED DESCRIPTION OF THE INVENTION

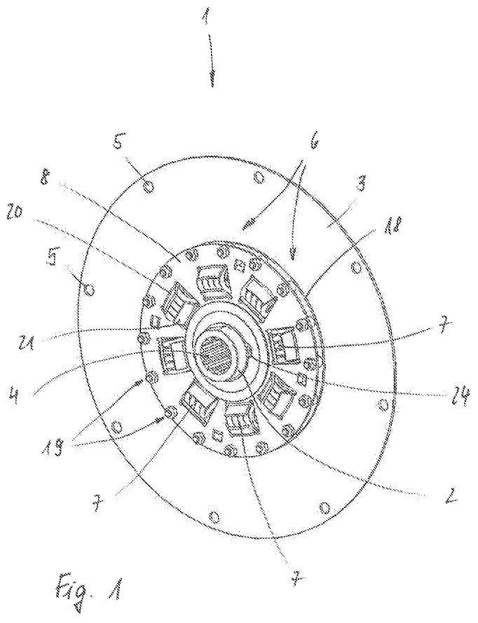

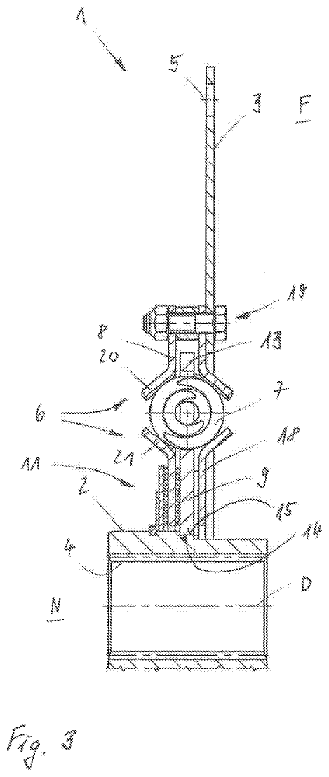

According to FIG. 1, a clutch device 1 is provided for a drive train for torsionally flexible torque transmission and has a clutch hub 2 lying radially to the inside with respect to a clutch rotational axis D (FIG. 3) and a clutch flange 3 lying radially to the outside.

The clutch hub 2 is assigned to a hub side N of the clutch device 1 and is provided in the present case for the torque-proof connection to a transmission input shaft of the drive train. For this purpose, the clutch hub 2 has in the present case a spline 4 formed at an inner circumference. The spline 4 is provided for an interlocking connection with a complementary spline of said transmission input shaft.

The clutch flange 3 is assigned to a flange side F of the clutch device 1 and is provided in the present case for the torque-proof connection to an output flange of a drive motor of the drive train. For this purpose, the clutch flange 3 in the present case has a plurality of bores 5 that are arranged to be spaced in the circumferential direction. The bores 5 are each provided for receiving a fastening means.

The clutch device 1 also has a spring device 6 by means of which the hub side N and the flange side F support each other in a resilient torque-transmitting manner in the circumferential direction. In the present case, the spring device 6 has 8 spring elements 7 that are arranged evenly spaced in the circumferential direction. However, this is not mandatory. In an embodiment which is not shown, the spring device can also have a number deviating therefrom, or even only a single spring element.

The spring elements 7 are each supported in the circumferential direction at one end by a first support component 8 assigned to the clutch flange 3. At the other end, the spring elements 7 are each supported in the circumferential direction by a second support component 9 assigned to the clutch hub 2.

The spring device 6 ensures that the torque to be transmitted between the flange side F and the hub side N is not transmitted more-or-less suddenly but elastically cushioned in the case of drive-related rough operation and/or torque peaks. Accordingly, the spring device 6 permits an elastic twist angle, not described in greater detail, between the flange side F and the hub side N, or between the clutch flange 3 and the clutch hub 2.

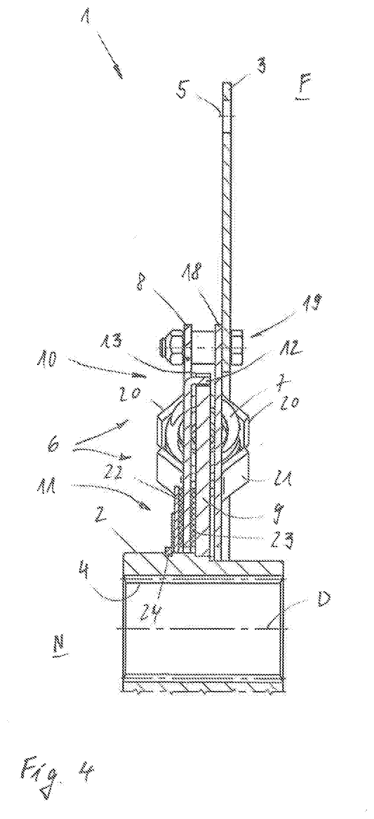

In order to limit the twist angle and to avoid possible overloading of the spring elements 7 from excessive rotation, a stop device 10 is provided (FIG. 4) by means of which the hub side N and the flange side F support each other in an interlocking torque-transmitting manner in the circumferential direction when a structurally defined maximum twist angle is reached.

In the present case, the clutch device 1 also has a friction device 11. By means of the friction device 11, the flange side F and the hub side N frictionally support each other in the circumferential direction in a torque-transmitting manner. This additional frictional support ensures damping of said rough operation and/or torque peaks. However, the friction device 11 provided here is not mandatory. In an embodiment which is not shown, such a friction device is not provided.

In the present case, the stop device 10 has at least one first interlocking element 12 formed integrally with the first support component 8, and at least one second interlocking element 13 formed integrally with the second support component 9. When the maximum twist angle between the flange side F and the hub side N is reached, the first interlocking element 12 and the second interlocking element 13 interlock to transmit torque and limit the twist angle.

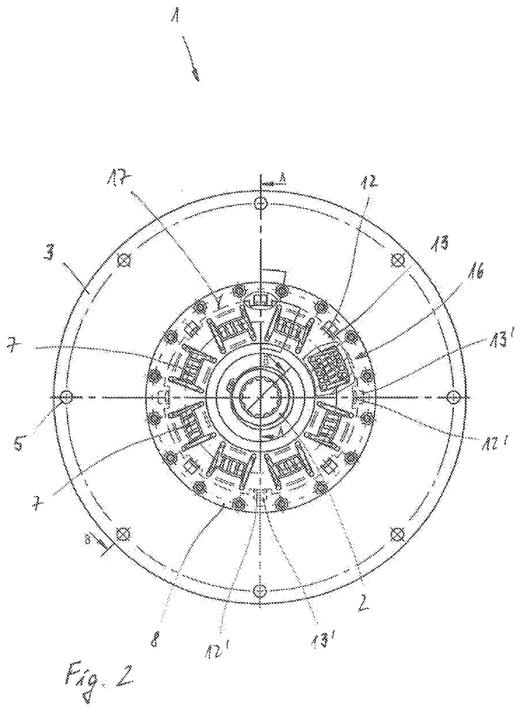

In the present case, the stop device 10 has a plurality of first interlocking elements 12 that are arranged to be spaced in the circumferential direction and correspondingly a plurality of second interlocking elements 13 that are arranged to be spaced in the circumferential direction (FIGS. 1, 2). The first interlocking elements 12 and the second interlocking elements 13 are each designed to be similar, wherein a first interlocking element 12 interacts with a respective second interlocking element 13. In order to avoid repetitions, only one of the first interlocking elements 12 and one of the second interlocking elements 13 is subsequently referenced in detail, wherein the related disclosed subject matter may correspondingly apply correspondingly to the remaining first interlocking elements 12 and the remaining second interlocking elements 13.

The first support component 8 serves for torque transmission with conjoint rotation between the clutch flange 3 and the spring device 6. Accordingly, the second support component 9 serves for torque transmission with conjoint rotation between the spring device 6 and the clutch hub 2. By respectively integrally forming the interlocking elements 12, 13 on the respective support component 8, 9, a particularly simple structural design can be achieved along with simple manufacturing and assembly of the clutch device 1.

In the present case, both the first support component and the second support component are each designed in the form of a sheet-metal component 8, 9 made of sheet metal. The sheet-metal components 8, 9 are each produced from a steel sheet not specified in more detail. The first interlocking element is a shaped sheet-metal section 12 of the sheet-metal component 8 that is described in more detail below. In the present case, the second interlocking element is an opening 13 which is cut out of the second sheet-metal component 9 and into which the shaped sheet-metal section 12 engages axially. When the maximum twist angle is reached, the shaped sheet-metal section 12 and the opening 13 contact each other in an interlocking manner in the circumferential direction so that a further resilient twisting between the flange side F and the hub side N is prevented.

In the present case, the second support component or the sheet-metal component 9 assigned to the clutch hub 2 is a support plate which can also be termed a center plate 9. The center plate 9 has an annular basic shape in the present case and is integrally bonded at its inner circumference 14 to an outer circumference 15 of the clutch hub 2. As the joint connection between the clutch hub 2 and the center plate 9, an unspecified weld connection is provided in the present case. The center plate 9 extends radially to the outside from the clutch hub 2 and has a plurality of recesses 16 arranged adjacently in the circumferential direction (FIG. 2), in each of which one of the spring elements 7 is accommodated. The recesses 16 extend in the axial direction and are matched to an outer contour of the spring elements 7 so that they are held at the end face against the recesses 16 in the circumferential direction.

In the present case, the second interlocking element is an axial opening 13 (FIG. 2) which is formed on an outer circumference 17 of the center plate 19 in the form of a radial recess. In an embodiment which is not shown, the axial opening 13 can instead be designed in the form of a through-hole bounded on all sides.

In the present case, the first support component assigned to the clutch flange 3 is a first cage plate 8, a cage assembly 8, 18 which serves in particular for axial retention of the spring elements 7. The first cage plate 8 is arranged at an axial offset with respect to the center plate 9 and has an annular basic shape. On an unspecified outer circumference, the first cage plate 8 is connected to the clutch flange 3 for conjoint rotation by means of a plurality of screw connections 19 (FIGS. 3, 4) arranged adjacently in the circumferential direction.

The first cage plate 8 has a plurality of bending sections 20, 21 arranged adjacently in the circumferential direction. The bending sections 20, 21 are bent in the axial direction and serve to axially retain the spring elements 7 in an interlocking manner.

The first interlocking element is designed in the present case in the form of a bent tab 12 on the first cage plate 8. The bent tab 12 extends in the axial direction and projects into the axial hole 13 in the center plate 9 in the manner described above. In the present case, the bent tab 12 is formed by cutting out a region of the first cage plate 8, wherein the regionally cut-out area is bent in the axial direction out of the remaining sections of the first cage plate 8 while forming the tab 12.

The cage assembly 8, 18 in the present case is designed to be essentially mirror-symmetrical with respect to the center plate 9 so that a second cage plate 18 is provided. Like the first cage plate 8, the second cage plate 18 has unspecified bending sections 20, 21 which, together with the bending sections 20, 21 of the first cage plate 8, form receiving recesses for receiving one of the spring elements 7 in each case. At its outer circumference, the second cage plate 18 is connected to the clutch flange 3 and the first cage plate 8 for conjoint rotation by means of the screw connections 19.

It can be seen from FIG. 2 that in the present case, the second cage plate 18 also has first interlocking elements, each in the form of a bent tab 12′. The bent tabs 12′ of the second cage plate 18 project axially opposite the bent tabs 12 of the first cage plate 8 into corresponding axial openings 13′ of the center plate 9. The tabs 12 of the first cage plate 8 and the tabs 12′ of the second cage plate 18 are alternately arranged in the circumferential direction so that a tab 12 of the first cage plate 8 follows a tab 12′ of the second cage plate 18 and vice versa.

In the present case, the spring elements 7 are each designed in the form of a helical spring made of metal and to be subjected to pressure. However, such a design of the spring elements 7 is not mandatory. In an embodiment which is not shown, the spring elements 7 may instead be formed from an elastomeric material in a non-helical, solid block design.

In the present case, the friction device 11 is formed between the center plate 9 and the first cage plate 8 and has annular first and second friction elements 23, 22. The first friction element 23 is arranged in the axial direction between an unspecified axial end face of the center plate 9 and an axial end face of the first cage plate 8 facing the center plate 9. In contrast, the second friction element 22 is arranged on an end face of the first cage plate 8 which lies to the outside in the axial direction and faces away from the center plate 9, and is spring-loaded in the axial direction by means of an otherwise unspecified spring unit secured to an axial locking ring 24. The friction device 11 is thereby frictionally preloaded. In the case of an elastic twisting between the flange side F and the hub side N, the friction device 11 causes a damping of the spring mobility of the spring device 10 due to the frictional contact between the first cage plate 8 on the one hand and the center plate 9 on the other hand. As mentioned at the outset, neither the friction device 11 nor the specific embodiment thereof are mandatory.

What is claimed is:

1. A clutch device (1) for torsionally flexible torque transmission, comprising:
a clutch hub (2) that lies radially to the inside relative to a clutch rotational axis (D) and is assigned to a hub side (N) of the clutch device (1);
a clutch flange (3) that lies radially to the outside and is assigned to a flange side (F) of the clutch device (1);
a spring device (6) by means of which the hub side (N) and the flange side (F) support each other in the circumferential direction in a resilient torque-transmitting manner, for which purpose the spring device (6) has at least one spring element (7) that, in the circumferential direction, is supported at one end by a first support component (8) assigned to the clutch flange (3) and at the other end by a second support component (9) assigned to the clutch hub (2); and,
a stop device (10) by means of which the hub side (N) and the flange side (F) support each other in an interlocking torque-transmitting manner in the circumferential direction when a defined maximum twist angle is reached between the hub side (N) and the flange side (F),
characterized in that the stop device (10) has at least one first interlocking element (12) integrally formed with the first support component (8), and at least one second interlocking element (13) integrally formed with the second support component (9), wherein the first interlocking element (12) and the second interlocking element (13) interlock when the maximum twist angle is reached.

2. The clutch device (1) according to claim 1, characterized in that the first support component and/or the second support component is designed in the form of a sheet-metal component (8, 9) made of sheet metal, and that the first interlocking element and/or the second interlocking element is designed in the form of a shaped sheet-metal section (12).

3. The clutch device (1) according to claim 2, characterized in that a plurality of first interlocking elements (12) that are arranged to be spaced in the circumferential direction and a plurality of second interlocking elements (13) that are arranged to be spaced in the circumferential direction are provided.

4. The clutch device (1) according to claim 3, characterized in that the first support component is a first cage plate (8) of a cage assembly (8, 18) for holding the at least one spring element (7), wherein the first cage plate (8) is joined at its outer circumference to the clutch flange (3) in a torque-proof manner, and that the second support component is a support plate (9) which is joined at its inner circumference (14) to the clutch hub (2) in a torque-proof manner.

5. The clutch device (1) according to claim 4, characterized in that the at least one second interlocking element is an axial opening (13) cut out of the support plate (9), and that the at least one first interlocking element is a bent tab (12) of the first cage plate (8) extending into the axial opening (13).

6. The clutch device (1) according to claim 5, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

7. The clutch device (1) according to claim 4, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

8. The clutch device (1) according to claim 2, characterized in that the first support component is a first cage plate (8) of a cage assembly (8, 18) for holding the at least one spring element (7), wherein the first cage plate (8) is joined at its outer circumference to the clutch flange (3) in a torque-proof manner, and that the second support component is a support plate (9) which is joined at its inner circumference (14) to the clutch hub (2) in a torque-proof manner.

9. The clutch device (1) according to claim 8, characterized in that the at least one second interlocking element is an axial opening (13) cut out of the support plate (9), and that the at least one first interlocking element is a bent tab (12) of the first cage plate (8) extending into the axial opening (13).

10. The clutch device (1) according to claim 9, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

11. The clutch device (1) according to claim 8, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

12. The clutch device (1) according to claim 1, characterized in that a plurality of first interlocking elements (12) that are arranged to be spaced in the circumferential direction and a plurality of second interlocking elements (13) that are arranged to be spaced in the circumferential direction are provided.

13. The clutch device (1) according to claim 12, characterized in that the first support component is a first cage plate (8) of a cage assembly (8, 18) for holding the at least one spring element (7), wherein the first cage plate (8) is joined at its outer circumference to the clutch flange (3) in a torque-proof manner, and that the second support component is a support plate (9) which is joined at its inner circumference (14) to the clutch hub (2) in a torque-proof manner.

14. The clutch device (1) according to claim 13, characterized in that the at least one second interlocking element is an axial opening (13) cut out of the support plate (9), and that the at least one first interlocking element is a bent tab (12) of the first cage plate (8) extending into the axial opening (13).

15. The clutch device (1) according to claim 14, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

16. The clutch device (1) according to claim 13, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

17. The clutch device (1) according to claim 1, characterized in that the first support component is a first cage plate (8) of a cage assembly (8, 18) for holding the at least one spring element (7), wherein the first cage plate (8) is joined at its outer circumference to the clutch flange (3) in a torque-proof manner, and that the second support component is a support plate (9) which is joined at its inner circumference (14) to the clutch hub (2) in a torque-proof manner.

18. The clutch device (1) according to claim 17, characterized in that the at least one second interlocking element is an axial opening (13) cut out of the support plate (9), and that the at least one first interlocking element is a bent tab (12) of the first cage plate (8) extending into the axial opening (13).

19. The clutch device (1) according to claim 18, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.

20. The clutch device (1) according to claim 17, characterized in that the cage assembly (8, 18) has a second cage plate (18) which is arranged on a side of the support plate (9) facing away from the first cage plate (8) and is provided with at least one further tab (12′) which extends into a further axial opening (13′) in the support plate.
